(19) United States
(12) Patent Application Publication
(10) Pub. No.: US 2026/0033499 A1
(43) Pub. Date: Feb. 5, 2026

(54) METHOD FOR REDUCING THE QUANTITY OF SUGAR CONSUMED IN BAKED GOODS

(71) Applicant: Advanced Enzyme Technologies Ltd., Thane (W) (IN)

(72) Inventors: Vasant Laxminarayan RATHI, Yorba Linda, CA (US); Dipak RODA, Thane (IN)

(73) Assignee: Advanced Enzyme Technologies Ltd., Thane (W) (IN)

(21) Appl. No.: 19/288,257

(22) Filed: Aug. 1, 2025

Related U.S. Application Data
(60) Provisional application No. 63/678,155, filed on Aug. 1, 2024.

(51) Int. Cl. A21D 2/26; A21D 13/06

(52) U.S. Cl. CPC A21D 2/267; A21D 13/06

(57) ABSTRACT

A method for producing baked goods with less added sugar without compromising the taste, sweetness and flavor of the baked goods. The method includes adding the enzyme alternansucrase in the dough-making process and may reduce the amount of added sugar in various baked goods by 50% without compromising taste and flavor. Addition of enzyme alternansucrase also maintains/improves certain key sensory qualities of the baked goods.

### CROSS-REFERENCE TO RELATED APPLICATIONS

This application claims the benefit of U.S. Provisional Application No. 63/678,155, filed Aug. 1, 2024, the disclosure of which is hereby incorporated in its entirety by reference.

### TECHNICAL FIELD

The present invention relates to a method for reducing the quantity of sugar added in baked goods by using the enzyme alternansucrase.

### BACKGROUND

Excessive sugar consumption is a major concern in recent times. The American Heart Association recommends a limit for added sugars: no more than 100 calories per day for most women (equivalent of 6 teaspoons or approximately 25 grams of sugar) and 150 calories per day for most men (the equivalent of 9 teaspoons or approximately 36 grams of sugar). Nevertheless, the US population on average intakes added sugars well above recommended levels; the top two food sources responsible for higher sugar intake are sugar-sweetened beverages and sweet bakery products. Breads can also be a significant contributor to sugar intake even though they are not typically perceived as sweet. Sugar source in bread making can either be naturally present sugar from ingredients used or added during the processing to meet texture properties. Since multiple servings of bread may be consumed in a day, it would potentially contribute to high sugar intake. For example, enriched white bread and whole wheat bread have been found to have 4-11% sugar by flour weight. Also, in surveying nutrition fact panels for 11 retail breads, these breads contained a calculated amount of 2.6 to 9.1 grams of sugar per 50-gram typical reference amount customarily consumed for bread.

Various efforts have been made to reduce the glycemic index/sugar of sweetened food, baked goods, and drinks with limited efficacy.

Sugar substitutes (also known as artificial sweeteners) are gaining attention as a sugar replacement option. Although sugar substitutes are sweet without the calories or blood sugar spikes that occur with traditional sugar consumption, and don't cause tooth decay, they do have certain disadvantages of their own.

First, the use of sugar substitutes often leads to unsatisfactory baking results. Structural/textural properties are often inferior in baked goods with artificial sweeteners. This can impact commercial baking applications, and the marketability of the product.

There are also harmful effects associated with the use of artificial sweeteners. For example, some studies suggest that regular consumption of artificial sweeteners may disrupt the body's natural ability to regulate calorie intake and appetite, potentially leading to weight gain over time. Other research suggests that long-term and daily use of artificial sweeteners may increase the risk of stroke and heart diseases and may alter taste preferences and over the time may reduce the likeliness for nutritious food like fresh fruits and naturally sweet vegetables. Artificial sweeteners can affect gut microbiomes thus developing glucose intolerance.

One sugar substitute, stevia, sometimes may result in bloating, gas, and diarrhea. Another approved sugar substitute sorbitol (containing sugar alcohols and polyols) can cause an undesired laxative effect if too much is consumed. Aspartame is also one of the approved and widely studied substitute but it is considered to be unsafe for people who have a rare condition called phenylketonuria (PKU). Another sugar substitute sucralose can affect gut microbiome and increase inflammation in the body and leads the problems such as obesity and diabetes.

There is a need for a method that enables manufacturers of baked goods to add a less quantity of sugar to their products without affecting the sensory qualities particularly the taste.

There is also a need for an alternative method that mitigates or eliminates the negative health impacts commonly associated with conventional sugar substitutes, while maintaining the desired flavor profile of the baked goods.

Furthermore, there is also a need for a method which can overcome the inferior baking results that sugar replacements produce, particularly the poor texture and structural characteristics of baked goods.

### SUMMARY

The present invention relates to the method of producing baked goods with less added sugar where the baked goods have sensory qualities that are close to or better than the control of regular baked goods containing significantly more sugar, where the method comprises adding the enzyme alternansucrase with or without other enzymes. Enzyme alternansucrase reduces the amount of added sugar in baked goods by up to 50% while maintaining the sensory qualities of baked goods sweetness.

### BRIEF DESCRIPTION OF THE DRAWINGS

FIG. 1 depicts a visual appearance of white bread samples prepared under different conditions, including a control sample with no sugar reduction, a sample with a 33% reduction in added sugar, and additional samples with the same 33% sugar reduction supplemented with varying dosages of alternansucrase.

FIG. 2 depicts a visual appearance of white bread samples used in dosage testing, including a control sample with no sugar reduction, a sample with a 50% reduction in added sugar, and a sample with 50% sugar reduction supplemented with 25 ppm of alternansucrase.

FIG. 3 depicts a visual appearance of white bread samples evaluated for foldability, including a control sample with no sugar reduction, a sample with a 50% reduction in added sugar, and a sample with 50% sugar reduction supplemented with 25 ppm of alternansucrase.

FIG. 4 depicts a graph showing the slice firmness of white bread samples with no sugar reduction, a sample with 50% sugar reduction and a sample with 50% sugar reduction supplemented with 25 ppm of alternansucrase

FIG. 5 depicts a visual appearance of cookies with no sugar reduction, with 10% sugar reduction and a sample with 10% reduction in added sugar supplemented with 10 ppm of alternansucrase

FIG. 6 depicts a visual appearance of cupcake samples prepared under different conditions, including a control sample with no sugar reduction, a sample with a 10% reduction in added sugar, and samples with 10% sugar reduction supplemented with varying dosages of alternansucrase enzyme.

FIG. 7 depicts a visual appearance of white bread samples used in dosage testing, including a control sample with no sugar reduction, a sample with a 33% reduction in added sugar, a sample with 33% sugar reduction supplemented with 25 ppm of alternansucrase and a sample with 33% sugar reduction supplemented with 25 ppm of alternansucrase and 250 ppm of SREB (an enzyme blend to assist with sugar reduction).

FIG. 8 depicts a graphical representation of Loaf Firmness of white bread with no sugar reduction, a sample with a 33% reduction in added sugar, a sample with 33% sugar reduction supplemented with 25 ppm of alternansucrase, and a sample with 33% sugar reduction supplemented with 25 ppm of alternansucrase and 250 ppm of SREB (an enzyme blend to assist with sugar reduction).

FIG. 9 depicts a graphical representation of crust colour of white bread measured in ‘L’ (lightness from black to white) using control sample with no sugar reduction, a sample with a 33% reduction in added sugar, a sample with 33% sugar reduction supplemented with 25 ppm of alternansucrase, and a sample with 33% sugar reduction supplemented with 25 ppm of alternansucrase and 250 ppm of SREB (an enzyme blend to assist with sugar reduction).

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure are described herein. It is to be understood, however, that the disclosed embodiments are merely examples and other embodiments can take various and alternative forms. Various combinations and modifications of the features consistent with the teachings of this disclosure could be desired for specific applications or implementations.

One aspect of the present invention is directed towards a method with less added sugar where the baked goods have sensory qualities that are close to or better than the control of regular baked goods containing significantly more sugar, where the method comprises adding the alternansucrase with or without other enzymes.

In one embodiment, alternansucrase is reduced in an amount of added sugar in the various baked goods by up to 50% (w/w) as compared to the amount of sugar added to control of regular baked goods.

In one embodiment, the sensory qualities include prolonged softness, slice firmness, a delay in staling, finer grain, and improved foldability, springiness, aroma, crust color, and/or overall texture.

In one embodiment of the present invention, alternansucrase is added into the baked goods formulation in an amount ranging from 5 to 500 parts per million (ppm), calculated on a flour weight basis. The specific dosage may be selected based on the type of baked product, the desired level of sugar reduction, and the targeted sensory and structural attributes of the final product.

In an embodiment of the present invention, the flour used in the preparation of baked goods may be derived from, but is not limited to, cereal grains such as wheat, rye, barley, corn, rice, almond, hemp, starch and oats. These flours serve as the primary structural component of the baked goods and may be selected based on the desired nutritional profile, texture, and flavor characteristics of the final product.

In one embodiment, alternansucrase may be added to the preparation of various baked goods, including but not limited to different types of breads, cookies, cakes, pastries, muffins, savory baked goods, brownies and biscuits. Alternansucrase may be incorporated into these formulations either individually or as part of a blend, depending on the specific product requirements and desired functional outcomes

In an embodiment, an activity of alternansucrase used standalone or in blend preparation is 4100 U/g.

In one embodiment, alternansucrase and the enzyme blend may be added in either liquid or solid form.

In one embodiment of the present invention, addition of 25 ppm of alternansucrase into baked goods enables a 33% reduction in added sugar without compromising the taste, sweetness and sensory qualities of the final product or sometimes even making it better. This method also maintains or improves sensory qualities of baked goods when compared to conventional baked goods that contain significantly more sugar.

In one embodiment of the present invention, addition of 25 ppm of alternansucrase into baked goods enables a 50% reduction in added sugar without compromising the taste, sweetness and sensory qualities of the final product or sometimes even making it better. This method also maintains or improves sensory qualities of baked goods when compared to the conventional baked goods that contain significantly more sugar.

In one embodiment of the present invention, the addition of 10 ppm of alternansucrase into the cookie's formulation enables a 10% reduction in added sugar without compromising the taste, sweetness and sensory qualities of the products or sometime even making it better. This method also maintains or improves sensory qualities of baked goods when compared to the conventional cookies that contain significantly more sugar.

In one embodiment of the present invention, addition of 10 ppm of alternansucrase to the cupcake formulation enables a 10% reduction in added sugar without compromising the taste, sweetness and sensory qualities of cupcakes or sometime even making it better. This method also maintains/improves sensory qualities of cupcakes when compared to the conventional cupcakes that contain significantly more sugar.

In one embodiment of the present invention, addition of 25 ppm alternansucrase along with other enzymes formulation enables a 33% reduction in added sugar without compromising the taste, sweetness and sensory qualities of the products or sometimes even making it better. This method also maintains/improves sensory qualities of baked goods when compared to the conventional baked goods that contain significantly more sugar.

One or more of these embodiments demonstrate the versatility and effectiveness of alternansucrase in enabling sugar reduction across various baked goods without sacrificing consumer-acceptable quality.

Alternansucrase (EC 2.4.1.140) is a transferase enzyme which can transfer a D-glucosyl residue from sucrose to a glucan chain and produces α-1,3 and α-1,6 bonds in approximately equal amounts by alternating the linkage type. The enzyme has the ability to convert sucrose into gluco-oligomers or gluco-polymers of alternating α-1, 3 and α-1,6 linkages named “alternan”. Alternansucrase can speed up the sequential addition of glucose residues from sucrose to form an alternan polymer. Alternan is a glucan which has an alternating sequence of α-1,3 and α-1,6 glycosidic bonds.

Alternansucrase for use herein in one or more embodiments may be obtained from Leuconostoc mesenteroides, Leuconostoc citreum, or Streptococcus mutans.

In an embodiment, alternansucrase may be used in combination with one or more additional enzymes to prepare the baked goods.

In one embodiment, alternansucrase is used in combination with a sugar reduction enzyme blend containing fungal amylase, glucoamylase, invertase, maltogenic amylase, and maltodextrin to reduce the sugar content in baked goods up to 50% while maintaining the sensory qualities, sweetness and taste.

In an embodiment, the enzymes in the alternansucrase blend for sugar reduction can be used in any amount, and a representative range is 10-14% fungal amylase, 10-14% glucoamylase, 1-3% invertase, maltogenic amylase 0.5 to 10% and 72-76% maltodextrin.

In one embodiment, alternansucrase maintains or improves the sensory qualities of baked goods, including but not limited to volume, firmness, foldability, crumb grain, moisture-binding properties, softness, a delay in staling, finer grain, and texture, without compromising the overall sensory qualities of the final product. This enhancement contributes to the consumer acceptability of reduced-sugar baked goods by preserving key quality attributes typically associated with full-sugar formulations

“Sensory qualities” may refer to one or more of all sensory qualities, such as but not limited to aroma, appearance, crumb grain, taste, softness, spring back, firmness, foldability, mouthfeel, taste, sweetness, and/or overall likeability. Improved mouthfeel may refer to a moister mouthfeel. Improved crumb grain may refer to a finer or more uniform crumb grain. Improved moisture binding properties may refer to the bread retaining a higher moisture content after baking using the same baking process. Improved volume may refer to a higher volume. “Texture” may refer to one or more of all texture properties, such as but not limited to firmness or hardness, springiness, resilience, chewiness, cohesiveness, and gumminess. Improving texture may refer to any desirable improvement in texture properties for a specific baked goods, such as but not limited to any one or more of increased softness (or lower firmness or hardness), increased springiness, increased resilience, increased cohesiveness, and reduced gumminess, etc., and may depend on the specific baked good, formulation, and process in the desired improvement. The baked goods may be any baked goods, such as but not limited to bread, baguettes, tortillas, pizza crust, English muffins, biscuits, cake, muffins, cookies, crackers, and conchas.

### EXAMPLES

Examples are set forth below and are illustrative of different amounts, concentrations, time intervals and reaction conditions that can be utilized in practicing one or more embodiments.

Unless stated otherwise, the abbreviations used throughout the specification have the following meanings: ppm—Parts per Million, mM—millimolar, mL—milliliter, mg—milligram, rpm—Revolutions per Minute, U/mL—units per milliliter, min—minutes, h—hour, RH—relative humidity. The abbreviation “SR” in this text refers to sugar reduction. Alternansucrase has been abbreviated as “A” or “A. Sucrase” in some of the following tables and graphs.

### Example 1: Dosage Study in Bread with 33% Sugar Reduction

The effect of alternansucrase in different dosages in white bread with 33% sugar reduction was evaluated.

Process: Alternansucrase was tested at 5, 10, 25, 50, 100, and 500 ppm (flour weight basis) in white bread with 33% sugar reduction. Dough was mixed at 60 rpm for 3 minutes and 90 rpm for 6 min, fermented for 20 min at 24-26° C., scaled to 500 g, proofed for 60 min at 38° C. and 85% RH, and baked at 218° C. for 19 min.

Table 1 given below depicts the formulas of Bread Dosage Tests with 33% Sugar Reduction (flour weight basis) in white bread.

TABLE 1

| | | OA2 | OA3 | OA4 | OA5 | OA6 | OA7 | OA8 |
|---|---|---|---|---|---|---|---|---|
| | OA1 | 33% | 33% | 33% | 33% | 33% | 33% | 33% |
| Ingredients | Control | SR | SR | SR | SR | SR | SR | SR |
| Wheat Flour | 100.0% | 100.0% | 100.0% | 100.0% | 100.0% | 100.0% | 100.0% | 100.0% |
| Alternansucrase | — | — | 5 ppm | 10 ppm | 25 ppm | 50 ppm | 100 ppm | 500 ppm |
| Sugar | 9.0% | 6.0% | 6.0% | 6.0% | 6.0% | 6.0% | 6.0% | 6.0% |
| Salt | 1.0% | 1.0% | 1.0% | 1.0% | 1.0% | 1.0% | 1.0% | 1.0% |
| Calcium | 0.5% | 0.5% | 0.5% | 0.5% | 0.5% | 0.5% | 0.5% | 0.5% |
| Propionate | | | | | | | | |
| Instant Yeast | 3.0% | 3.0% | 3.0% | 3.0% | 3.0% | 3.0% | 3.0% | 3.0% |
| Shortening | 2.0% | 2.0% | 2.0% | 2.0% | 2.0% | 2.0% | 2.0% | 2.0% |
| Water | 60.0% | 60.0% | 60.0% | 60.0% | 60.0% | 60.0% | 60.0% | 60.0% |

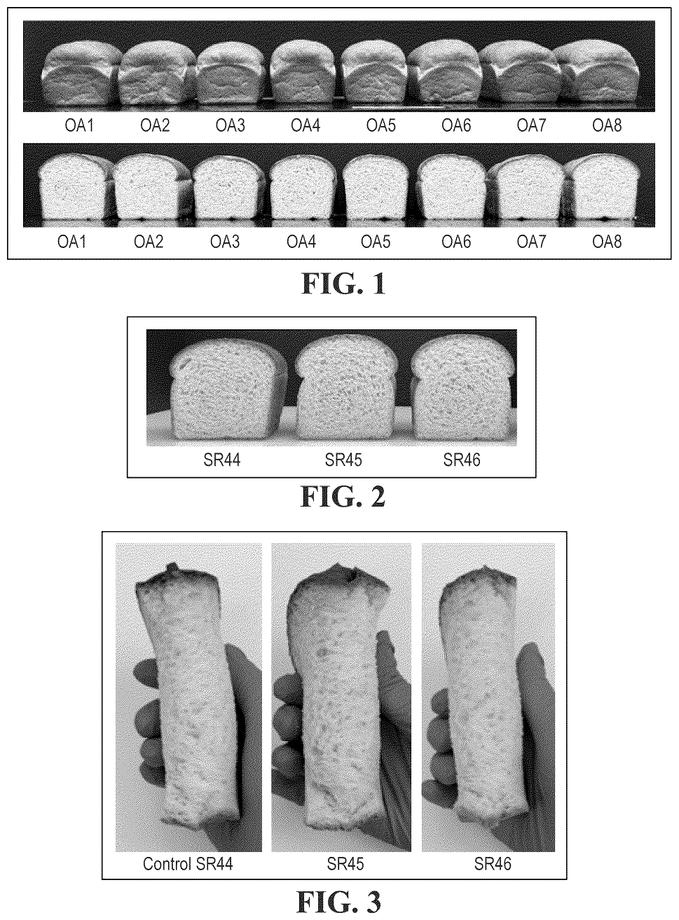

FIG. 1 shows White Bread Dosage Tests with 33% Sugar Reduction.

Pre-Screening: A pre-screening test was carried out on Day 1 to help identify the most promising samples, to reduce the bread samples evaluated by the sensory panel, and to prevent the panelist's testing fatigue.

The observations indicated that the bread samples containing 10, 25, and 50 ppm of alternansucrase showed the most potential for enhanced sweetness and overall likeability. Additionally, these doughs exhibited good handling properties, comparable to the control dough. In contrast, the doughs with higher concentrations of alternansucrase (100 and 500 ppm) were noticeably stickier and more difficult to work with.

Following this initial screening, the selected bread samples were further evaluated by the sensory panel on Day 14.

Sensory Evaluation: Breads were rated by 8 trained sensory panelists using a 9-point scale for general sensory attributes, and a time intensity test for sweetness. For the general sensory attributes, breads were rated by the sensory panel using a 9-point scale.

TABLE 2

| Attributes | Scale |
|---|---|
| Crumb grain | 1 = Very coarse & 9 = Very fine |
| Aroma | 1 = Strong off-aromas & 9 = Very pleasant |
| Softness | 1 = Very hard & 9 = Very soft |
| Mouthfeel | 1 = Very dry & 9 = Very moist |
| Taste | 1 = Very strong off-flavors 5 = Neutral & 9 = Very |
| | pleasant |
| Overall | 1 = Strongly dislike, 5 = Neutral, & 9 = Strongly like |
| likeability | |

Samples were presented to panelists with random 3-digit codes to maintain secrecy and to avoid the biasness.

Table 3 below describes the Results for sensory evaluation (Day 14) for Bread with 33% Sugar Reduction.

TABLE 3

| | | | 33% SR + | 33% SR + | 33% SR + |
|---|---|---|---|---|---|
| | | 33% | 10 ppm A. | 25 ppm A. | 50 ppm A, |
| Attribute | Control | SR | Sucrase | Sucrase | Sucrase |
| Crumb Grain | 4.6 | 3.8 | 4.2 | 4.8 | 5.0 |
| Aroma | 5.6 | 5.4 | 5.2 | 5.0 | 5.8 |
| Softness | 5.6 | 6.0 | 5.2 | 5.8 | 5.4 |
| Mouthfeel | 4.0 | 4.6 | 3.4 | 4.2 | 4.2 |
| Taste | 5.8 | 4.0 | 4.6 | 4.0 | 4.8 |
| Overall Likeability | 6.6 | 4.4 | 5.6 | 5.4 | 5.6 |
| Total Score | 32.2 | 28.2 | 28.2 | 29.2 | 30.8 |

On day 14, it was observed that the breads with 33% sugar reduction with 10, 25, and 50 ppm added alternansucrase rated better in overall likeability and crumb grain than the bread with only 33% sugar reduction. Another observation was that bread with 33% sugar reduction with 10, 25, and 50 ppm added alternansucrase were similar in overall likeability and crumb grain to the Control (without any sugar reduction).

Time intensity (TI) test for sweetness: This test is a sensory evaluation method used to assess how sweetness changes over time as a product is consumed. It is particularly useful in baking for understanding the sweetness profile of different recipes or ingredients, such as sweeteners. Time intensity test measures how sweetness intensity changes over time, rather than just at a single point. TI analysis can help compare the sweetness profiles of different sweeteners, like sucrose, artificial sweeteners (e.g., aspartame, sucralose), or natural sweeteners (e.g., stevia).

This test was conducted to evaluate the sweetness intensity of bread under different conditions: without alternansucrase, with alternansucrase, and with varying concentrations of alternansucrase. The objective was to determine how the presence and amount of alternansucrase influence the perceived sweetness of the bread, providing insights into its potential application as a sweetening agent in baked products. For this test, a 2% sucrose solution was used as a reference. Panelists were instructed to chew each sample for 20 seconds, swallow the sample at 20 seconds, and rate the sweetness on a scale of 1 to 9 (where 1=no sweetness, 5=same sweetness as a 2% sucrose solution reference, and 9=much sweeter than the 2% sucrose solution reference).

The time intervals considered were 0 seconds (start chewing the sample), 10, 20, and 30 seconds. Water was provided for panelists to rinse their palettes between samples, and panelists waited at least 30 seconds between tasting samples. Samples were presented to panelists with random 3-digit codes to maintain secrecy and to avoid the biasness.

Table 4 below describes the data for Time intensity test for sweetness for Bread with 33% Sugar Reduction.

TABLE 4

| | | Control | | 10 | 25 | 50 |
|---|---|---|---|---|---|---|
| | | (2% sucrose | 33% | ppm A. | ppm A. | ppm A. |
| Time | | solution) | SR | Sucrase | Sucrase | Sucrase |
| 0 | Seconds | 2.5 | 3.0 | 3.5 | 2.5 | 2.5 |
| 10 | Seconds | 3.0 | 3.0 | 3.0 | 3.5 | 2.5 |
| 20 | Seconds | 3.5 | 3.0 | 3.0 | 4.0 | 3.0 |
| 30 | seconds | 4.5 | 3.5 | 3.0 | 3.5 | 2.5 |

| | | | | | |
|---|---|---|---|---|---|
| Total Time Intensity | 13.5 | 12.5 | 12.5 | 13.5 | 10.5 |
| Sweetness Score | | | | | |

It was observed that on Day 14, bread with 25 ppm alternansucrase rated sweeter in total time intensity sweetness score than the 33% sugar reduction and also rated similar in time intensity sweetness score to the Control (no sugar reduction).

Results: The results and data of this study suggest that—
1. Adding 25 ppm alternansucrase to bread with a 33% sugar reduction provides a sweetness level comparable to that of regular white bread with no sugar reduction.
2. 25 ppm alternansucrase also improved the overall likeability and crumb grain of the white bread with 33% sugar reduction making it more similar to the control bread with no sugar reduction.

### Example 2: Bread with 50% Sugar Reduction

The effect of adding 25 ppm alternansucrase in white bread with 50% sugar reduction was evaluated in this study.

Process: Alternansucrase was tested at 5, 10, 25, 50, 100, and 500 ppm (flour weight basis) in white bread with 50% sugar reduction following the same process as described in example 1.

Table 5 below describes the Formulas for Bread Tests with 50% Sugar Reduction

TABLE 5

| | | | SR46 | |
|---|---|---|---|---|
| | Control | SR45 | (50% SR + 25 ppm | |
| Ingredients | (SR44) | (50% SR) | Alternansucrase) | |
| Wheat Flour | 100.0% | 100.0% | 100.0% | |
| SEBake Fresh | 100 ppm | 100 ppm | 100 | ppm |
| Ultra* | | | | |
| Alternansucrase | — | — | 25 | ppm |

| | | | |
|---|---|---|---|
| Sugar | 9.0% | 4.5% | 4.5% |
| Salt | 1.0% | 1.0% | 1.0% |
| Calcium Propionate | 0.5% | 0.5% | 0.5% |
| Instant Yeast | 3.0% | 3.0% | 3.0% |
| Shortening | 2.0% | 2.0% | 2.0% |
| Water | 60.0% | 60.0% | 60.0% |

*SEBake fresh Ultra is maltogenic alpha-amylase.

FIG. 2 below shows the Bread Tests with 50% Sugar Reduction.Parameters like foldability and slice firmness were also studied for evaluation of the bread quality. Foldability was rated on Day 7 using a scale of 1-9 by a trained expert, where 1=breaks completely, 5=half breaks, and 9=stays completely intact when folded.

TABLE 6 depicts Foldability of Bread with 50% Sugar Reduction.

TABLE 6

| | | | SR 46 (50% SR + |
|---|---|---|---|
| | | | 25 ppm |
| Attribute | Control (SR 44) | 50% SR (SR 45) | Alternansucrase) |
| Day 7 | 8 | 7 | 8.5 |

FIG. 3 shows foldability of bread with 50% sugar reduction.

Results indicated that 25 ppm alternansucrase improved the foldability of bread with 50% sugar reduction. 25 ppm alternansucrase added in bread with 50% sugar reduction rated similar in foldability to the control (no sugar reduction) and stayed better intact when folded than bread with 50% sugar reduction (50% SR).

Slice Firmness: Slice firmness refers to the resistance of a bread slice to deformation or compression, serving as a key indicator of its texture and freshness. In the texture analysis of baked goods, instruments like the Texture Analyzer are used to measure force (in Newtons, N), which is essential for quantifying attributes such as hardness, crispness, and chewiness. These force measurements provide objective data by correlating the applied pressure with the extent of deformation or breakage. This analysis plays a vital role in assessing the overall quality and consumer appeal of products like bread, cakes, and pastries.

In this experiment on Day 7, bread with 50% sugar reduction and 25 ppm alternansucrase was 11% softer in slice firmness than the 50% sugar reduction bread, suggesting that alternansucrase can help delay staling and prolong softness. Bread with 50% sugar reduction and 25 ppm alternansucrase was also more similar in slice firmness to the Control (no sugar reduction) than bread with 50% sugar reduction (50% SR).

TABLE 7 shows Slice Firmness (N) of White Bread with 50% Sugar Reduction.

TABLE 7

| Time | SR 44 | SR 45 | SR 46 |
|---|---|---|---|
| Day 1 | 5.92 | 7.45 | 6.54 |
| Day 7 | 7.93 | 9.19 | 8.16 |

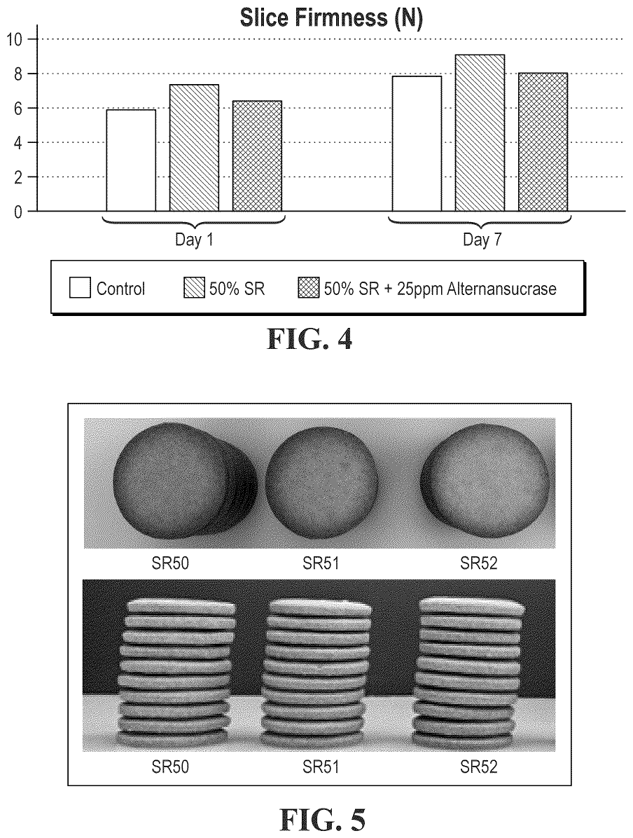

FIG. 4 represents Slice Firmness of Bread with 50% Sugar Reduction.

Time intensity test for sweetness: The process followed for this test is same as explained in example 1.

TABLE 8 describes total Time Intensity Sweetness Score of Bread with 50% Sugar Reduction.

TABLE 8

| Time | | Control (SR44) | SR 45 | SR 46 |
|---|---|---|---|---|
| 0 | Seconds | 3.9 | 2.8 | 2.9 |
| 10 | Seconds | 4.6 | 4.0 | 3.3 |
| 20 | Seconds | 4.5 | 3.0 | 3.9 |
| 30 | seconds | 4.3 | 2.9 | 4.5 |

| | | | |
|---|---|---|---|
| Total Time Intensity Sweetness Score | 17.3 | 12.6 | 14.5 |

The results of this test exhibited that the bread with 50% sugar reduction with 25 ppm alternansucrase added rated sweeter in the total time intensity sweetness score than the 50% sugar reduction bread. It was closer in sweetness to the control than the bread with 50% sugar reduction (by time intensity sweetness score as described in example 1).

Results: The results and data of this study suggest that—
1. Adding 25 ppm alternansucrase to bread with a 50% sugar reduction improved its foldability. The treated bread was rated similar in foldability to the control (no sugar reduction) and remained more intact when folded compared to untreated 50% sugar-reduced bread.
2. Bread with a 50% sugar reduction and 25 ppm alternansucrase was 11% softer in slice firmness compared to bread with 50% sugar reduction alone, suggesting that alternansucrase may help delay staling and prolong softness. Additionally, the slice firmness of the alternansucrase-treated bread was more similar to the control (no sugar reduction) than the untreated 50% sugar-reduced bread.
3. The results showed that bread with a 50% sugar reduction and 25 ppm alternansucrase scored higher in total time intensity sweetness than bread with 50% sugar reduction alone. Its sweetness was also closer to that of the control bread (no sugar reduction), indicating that alternansucrase enhances sweetness perception in reduced-sugar formulations.

### Example 3: Cookies with 10% Sugar Reduction

The effect of adding 10 ppm alternansucrase in cookies with 10% sugar reduction was evaluated in this study.

Process: Butter, sugar, and eggs were combined and mixed for 5 minutes at 120 rpm. Dry ingredients were added and mixed for 2 minutes at 40 rpm. The dough was sheeted and placed in the fridge for 15 minutes, cut using a 58 mm diameter cookie cutter, and then placed in the freezer for 15 minutes. Cookies were lined on parchment paper and baked for 15 minutes at 350° F. and cooled for 15 minutes before storing.

TABLE 9
depicts Formulas for Cookies with 10% Sugar Reduction (flour weight basis).

| | SR 50 | SR 51 | (SR 52) 10% SR + | |
|---|---|---|---|---|
| Ingredients | (Control) | (10% SR) | 10 ppm Alternansucrase | |
| SEBake Fresh Ultra* | 100 ppm | 100 ppm | 100 | ppm |
| Alternansucrase | — | — | 10 | ppm |

| | | | |
|---|---|---|---|
| Wheat Flour | 100.0% | 100.0% | 100.0% |
| Baking Powder | 2.0% | 2.0% | 2.0% |
| Sugar | 50.0% | 45.0% | 45.0% |
| Egg | 20.0% | 20.0% | 20.0% |
| Butter | 48.0% | 48.0% | 48.0% |

*SEBake fresh ultra is maltogenic alpha amylase

FIG. 5 shows Cookies with 10% Sugar Reduction.Parameters like firmness, fracture force, colour, sweetness, and sugar profile were studied for evaluation of the quality of cookies.

Firmness: It refers to the resistance of a cookie to deformation or compression, serving as a key indicator of its texture and freshness. In the texture analysis of baked goods, instruments like the Texture Analyzer are used to measure force (in Newtons, N), which is essential for quantifying attributes such as hardness, crispness, and chewiness. Table 10 depicts the Firmness (N) of Cookies with 10% Sugar Reduction.

TABLE 10

| | | 10% | 10% SR + 10 ppm |
|---|---|---|---|
| Test | Control | SR | Alternansucrase |
| Day 7 | 20.26 | 26.25 | 20.99 |

It was observed that on day 7, cookies with 10% sugar reduction (10% SR) were 29% firmer than the Control. It appears that reducing sugar resulted in increased staling of the cookies. Cookies with 10% sugar reduction+10 ppm alternansucrase were 20% softer than the 10% sugar reduction cookies (10% SR) and were close in firmness to the Control (No sugar reduction) on day 7.

These results also suggest that 10 ppm alternansucrase can help delay staling in cookies with 10% sugar reduction, keeping them softer for longer and similar in firmness to the control cookies (without sugar reduction).

Analysis of Fracture Force: Fracture force for cookies refers to the amount of force required to break or fracture a cookie, and it is a key parameter in evaluating crispness and brittleness—two important textural attributes in baked goods. It is measured by instruments like the Texture Analyzer and is measured in Newtons, N.

TABLE 11 refers to the Fracture Force (N) of Cookies with 10% Sugar Reduction.

TABLE 11

| | | 10% | 10% SR + 10 ppm |
|---|---|---|---|
| Test | Control | SR | Alternansucrase |
| Day 7 | 11.75 | 18.00 | 8.73 |

On day 7, it was observed that cookies with a 10% sugar reduction exhibited a fracture force that was 53% higher than the control group (no sugar reduction). This indicates that the 10% sugar-reduced cookies were significantly harder to break. Interestingly, the addition of 10 ppm alternansucrase to the 10% sugar-reduced cookies resulted in a lower fracture force compared to the 10% sugar reduction cookies alone. The fracture force of these cookies was closer to that of the control group.

These findings suggest that incorporating 10 ppm alternansucrase can effectively reduce the fracture force of cookies with a 10% sugar reduction, making them easier to break and more similar in texture to the control cookies.

Colour Analysis of baked goods: Colour is a significant indicator to the consumer as it can imply taste, texture, and overall quality. Biscuits that are too light in color can appear to be underbaked; similarly, bread that is too dark may be perceived as dry, starchy, or overbaked. In baking, the L, a, and b values from a texture analyzer, which are part of the Lab color space, are used to objectively measure and quantify the color of baked goods. ‘L’ represents lightness (from black to white), while ‘a’ and ‘b’ represent chromaticity (red-green and yellow-blue, respectively). This data helps in understanding the impact of ingredients and baking conditions on the final product's color, ensuring consistent quality and consumer appeal.

Table 12 describes the colour of Cookies with 10% Sugar Reduction.

TABLE 12

| | | 10% | 10% SR + 10 ppm |
|---|---|---|---|
| Test | Control | SR | Alternansucrase |
| Color | 65.9 | 66.1 | 64.3 |
| by L* | | | |

Cookies with 10% sugar reduction+10 ppm alternansucrase were darker (lower L* value) than the cookies with 10% sugar reduction. This suggests that 10 ppm alternansucrase can help to maintain colour (development of darker colour) in cookies with 10% sugar reduction closer to control.

Time intensity test for sweetness: In this time-intensity sweetness test, a 5% sucrose solution was used as the reference standard, (2% solution used in Example 1). This adjustment was made because the cookies being evaluated were sweeter than those in the previous test, necessitating a more concentrated reference to accurately calibrate the sweetness scale. The 5% sucrose solution was assigned a sweetness rating of 5, allowing panelists to better assess and compare the sweetness of the cookies over time without encountering ceiling effects. This refined approach ensures more precise and meaningful sensory evaluation results.

TABLE 13 below depicts Time Intensity Sweetness Data for Cookies with 10% Sugar Reduction on Day 7.

TABLE 13

| | | | 10% SR + |
|---|---|---|---|
| | | | 10 ppm |
| Time | Control | 10% SR | Alternansucrase |

| | | | | |
|---|---|---|---|---|
| 0 | Seconds | 2.0 | 2.4 | 3.0 |
| 10 | Seconds | 4.4 | 4.0 | 4.3 |
| 20 | Seconds | 5.3 | 4.4 | 5.3 |
| 30 | Seconds | 5.4 | 4.0 | 4.6 |

| | | | |
|---|---|---|---|
| Total Time Intensity | 17.1 | 14.9 | 17.1 |
| Sweetness Score | | | |

During the time intensity sweetness test, it was observed that the cookies with a 10% sugar reduction in combination with 10 ppm alternansucrase received a higher total time intensity sweetness score compared to the cookies with only a 10% sugar reduction. Notably, the sweetness of the 10% sugar reduction plus 10 ppm alternansucrase cookies was similar to that of the control cookies.

These findings indicate that incorporating 10 ppm alternansucrase may effectively enhance the perceived sweetness of cookies with a 10% sugar reduction, bringing their sweetness level in line with the Control sample (without sugar reduction).

Sugar Profile: TABLE 14 below shows Sugar Profile of Cookies with 10% Sugar Reduction.

TABLE 14

| Name | Description | Fructose | Glucose | Sucrose | Maltose | Total |
|---|---|---|---|---|---|---|
| SR50 | Control | 0.8% | 0.8% | 35.0% | 0.0% | 36.6% |
| SR51 | 10% SR | 0.4% | 0.5% | 33.6% | 0.0% | 34.5% |
| SR52 | 10% SR + 10 ppm | 0.5% | 0.4% | 32.8% | 0.0% | 33.7% |
| | Alternansucrase | | | | | |

It was found that the cookies with added enzymes had 0.8-1.3% less sucrose and total sugar (of product weight) than the cookies with 10% sugar reduction (10% SR). This suggests that 10 ppm alternansucrase can help slightly reduce sugar in cookies with a 10% sugar reduction.

Results: The results and data of this study suggest that—
1. Adding 10 ppm alternansucrase in cookies with 10% sugar reduction can help delay staling, keeping them softer for longer period and similar in firmness to the Control cookies (without sugar reduction).
2. Adding 10 ppm alternansucrase in cookies with 10% sugar reduction can effectively reduce the fracture force of cookies, making them easier to break and more similar in texture to the control cookies.
3. Adding 10 ppm alternansucrase can also help improve colour (development of darker colour) in cookies with 10% sugar reduction.
4. 10 ppm alternansucrase added in cookies with 10% sugar reduction provides a sweetness level comparable to that of the control, i.e. cookies with no sugar reduction.

### Example 4: Dosage Study in Cupcakes with 10% Sugar Reduction

The effect of alternansucrase in different dosages was studied in cupcakes with 10% sugar reduction.

Process: Alternansucrase was tested at 10, 25, 50, and 100 ppm of flour weight basis in cupcakes with 10% sugar reduction to optimize the dose. To prepare the cupcakes butter, sugar, and eggs were creamed for 5 minutes at 120 rpm. Then dry ingredients were added and mixed for 1 minute at 40 rpm, following which remaining wet ingredients were added and mixed for 1 minute at 40 rpm. The speed was increased to 120 rpm and mixed for an additional 4 minutes. Cupcakes were scaled to 51 g and baked at 350 F for 30 minutes, then cooled for 1 hour before storing.

TABLE 15 depicts Formulas for Cupcake Tests with 10% Sugar Reduction (flour weight basis).

TABLE 15

| | | | OA11 | OA12 | OA13 | OA14 |
|---|---|---|---|---|---|---|
| | | OA10 | 10% SR + | 10% SR + | 10% SR + | 10% SR + |
| | OA9 | 10% | 10 ppm | 25 ppm | 50 ppm | 100 ppm |
| Ingredients | Control | SR | Alternansucrase | Alternansucrase | Alternansucrase | Alternansucrase |
| Alternansucrase | — | — | 10 ppm | 25 ppm | 50 ppm | 100 ppm |
| Sugar | 72.8% | 65.5% | 65.5% | 65.5% | 65.5% | 65.5% |
| Butter | 45.6% | 45.6% | 45.6% | 45.6% | 45.6% | 45.6% |
| Wheat Flour | 100.0% | 100.0% | 100.0% | 100.0% | 100.0% | 100.0% |
| Baking Powder | 8.0% | 8.0% | 8.0% | 8.0% | 8.0% | 8.0% |
| Milk Solids | 12.0% | 12.0% | 12.0% | 12.0% | 12.0% | 12.0% |
| Salt | 1.5% | 1.5% | 1.5% | 1.5% | 1.5% | 1.5% |
| Potassium | 1.0% | 1.0% | 1.0% | 1.0% | 1.0% | 1.0% |
| Sorbate | | | | | | |
| Eggs | 45.6% | 45.6% | 45.6% | 45.6% | 45.6% | 45.6% |
| Water | 64.0% | 64.0% | 64.0% | 64.0% | 64.0% | 64.0% |
| Vanilla | 2.4% | 2.4% | 2.4% | 2.4% | 2.4% | 2.4% |
| Oil | 24.0% | 24.0% | 24.0% | 24.0% | 24.0% | 24.0% |

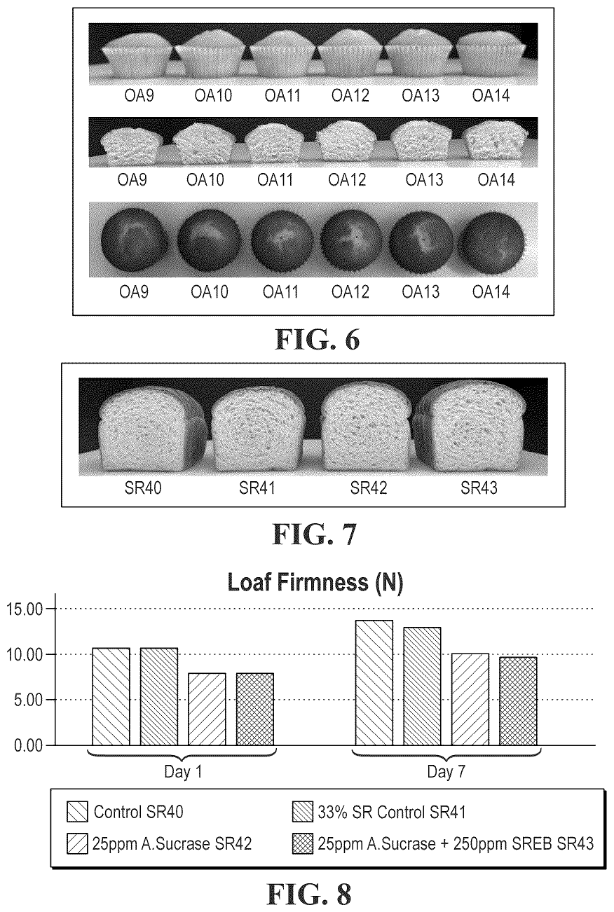

FIG. 6 shows Cupcakes with 10% Sugar Reduction (SR).

Parameters like firmness, colour, and sugar profile were studied for evaluating the quality of the cupcakes.

Firmness: It was observed on Day 4 that the cupcakes with a 10% sugar reduction combined with 10 ppm alternansucrase showed similar firmness to the control. However, the other formulations with a 10% sugar reduction (OA10, OA12, OA13, and OA14) were softer than the control. This suggests that the higher sugar content in the control sample likely contributes to the structure and firmness of the cupcakes.

Interestingly, while cupcakes with a 10% sugar reduction were generally softer, the addition of 10 ppm alternansucrase appeared to increase their firmness to a level comparable to the control. In contrast, higher concentrations of alternansucrase in the 10% sugar reduction cupcakes resulted in a softer texture.

These findings indicate that 10 ppm alternansucrase may potentially improve the structure, specifically the firmness, of cupcakes when the sugar content is reduced by 10%.

TABLE 16 describes the Firmness (N) of Cupcakes with 10% Sugar Reduction. Firmness and unit of measurement are described in example 2.

TABLE 16

| | | | 10% SR + | 10% SR + | 10% SR + | 10% SR + |
|---|---|---|---|---|---|---|
| | | 10% | 10 ppm | 25 ppm | 50 ppm | 100 ppm |
| Day | Control | SR | A. Sucrase | A. Sucrase | A. Sucrase | A. Sucrase |
| 1 | 5.4 | 5.3 | 5.4 | 5.3 | 5.0 | 5.0 |
| 4 | 8.6 | 7.9 | 8.6 | 8.0 | 7.4 | 7.4 |

Colour: TABLE 17 represents the Colour of Cupcakes with 10% Sugar Reduction. Method for measuring the crust colour is described in example 2.

TABLE 17

| | | | 10% SR + | 10% SR + | 10% SR + | 10% SR + |
|---|---|---|---|---|---|---|
| | | | 10 | 25 | 50 | 100 |
| | | 10% | ppm A. | ppm A. | ppm A. | ppm A. |
| Test | Control | SR | Sucrase | Sucrase | Sucrase | Sucrase |
| Crust Color by L* | 63.0 | 64.2 | 65.3 | 65.6 | 62.1 | 60.3 |

It was evident that 50 and 100 ppm alternansucrase improved the crust colour (developed darker colour) of cupcakes with 10% sugar reduction.

Sugar profile: TABLE 18 shows Sugar Profile of Cupcakes with 10% Sugar Reduction.

TABLE 18

| Name | Description | Fructose | Glucose | Sucrose | Maltose | Total Sugar |
|---|---|---|---|---|---|---|
| OA9 | Control | 0.0% | 0.0% | 28.8% | 0.0% | 28.8% |
| OA10 | 10% SR | 0.0% | 0.0% | 28.0% | 0.0% | 28.0% |
| OA11 | 10% SR + 10 ppm A. Sucrase | 0.0% | 0.0% | 27.2% | 0.0% | 27.2% |
| OA12 | 10% SR + 25 ppm A. Sucrase | 0.0% | 0.0% | 27.3% | 0.0% | 27.3% |
| OA13 | 10% SR + 50 ppm A. Sucrase | 0.0% | 0.0% | 25.8% | 0.0% | 25.8% |
| OA14 | 10% SR + 100 ppm A. Sucrase | 0.0% | 0.0% | 24.5% | 0.0% | 24.5% |

It was noted that the cupcakes with alternansucrase had 0.7-3.5% less sucrose and total sugar content (of product weight) than the 10% sugar reduction cupcakes (10% SR). This suggests that alternansucrase may be able to help further reduce sucrose and total sugar content in cupcakes.

Sensory Evaluation: For the general sensory attributes, cupcakes were rated by the sensory panel using a 9-point scale as described in Example 1. For sweetness, 1=no sweetness, 5=same sweetness as reference (which was the Control (no sugar reduction)), and 9=very sweet. For other sensory attributes, refer example 1.

TABLE 19 depicts Sensory Data of Cupcakes with 10% Sugar Reduction.

TABLE 19

| | | | 10% SR + | 10% SR + | 10% SR + |
|---|---|---|---|---|---|
| | | 10% | 10 ppm A. | 25 ppm A. | 100 ppm A. |
| Sensory Attribute | Control | SR | Sucrase | Sucrase | Sucrase |
| Crumb Grain | 6.9 | 7.4 | 7.9 | 7.3 | 7.4 |
| Aroma | 7.9 | 5.7 | 7.1 | 7.4 | 5.3 |
| Softness | 8.1 | 6.6 | 7.0 | 6.0 | 7.1 |
| Mouthfeel | 8.0 | 6.1 | 6.4 | 6.3 | 6.6 |
| Overall | 6.1 | 4.0 | 4.9 | 4.3 | 4.9 |
| Sweetness | | | | | |
| Taste | 6.7 | 5.9 | 6.0 | 5.9 | 6.4 |
| Total Sensory | 43.7 | 35.7 | 39.3 | 37.1 | 37.7 |
| Score | | | | | |

Results: The results and data of this study suggest that—
1. Cupcakes containing 10% sugar reduction (SR) combined with alternansucrase received a higher total sensory score compared to cupcakes with 10% SR alone. Remarkably, their total sensory score was also closer to that of the control cupcakes.
2. Cupcakes with 10 and 100 ppm alternansucrase were rated as sweeter in overall sweetness than the 10% SR cupcakes. This is promising as the sweetness of the cupcakes with 10% sugar reduction can be enhanced without producing more sugar in the cupcakes, thus also keeping the cupcakes healthier.
3. The 10% sugar reduction cupcakes had a coarser crumb grain and softer texture than the control. The addition of 10 ppm alternansucrase resulted in an improved crumb grain in the cupcakes, making it finer than both the 10% SR and the control cupcakes. A finer crumb grain is generally considered more desirable in cupcakes.
4. Cupcakes with 10% SR and the addition of 10 and 25 ppm alternansucrase exhibited an improved aroma, more closely resembling that of the control cupcakes when compared to the cupcakes with 10% SR alone.
5. The results suggest that 10 ppm alternansucrase can be used to improve the crumb grain, sweetness, and aroma of cupcakes with 10% sugar reduction, to be more similar to the Control cupcakes.
6. The best dose was found to be 10 ppm alternansucrase for cupcakes with 10% sugar reduction for overall quality and sensory.

### Example 5

Dosage Study of Alternansucrase and Enzyme Blend in White Bread with 33% Sugar Reduction

A subsequent study was run to evaluate the effect of combining alternansucrase and SREB (an enzyme blend to assist with sugar reduction) for white bread with 33% sugar reduction. The following formulas were tested using the same process described in Example 1.

FIG. 7—White Bread Tests with 33% Sugar Reduction

| | | | |
|---|---|---|---|
| SR40 | SR41 | SR42 | SR43 |
| Control | 33% SR | 33% SR + 25 ppm | 33% SR + 25 ppm |
| | Control | A. Sucrase | A. Sucrase + |
| | | | 250 ppm SREB |

TABLE 18—Formulas for White Bread Tests with 33% Sugar Reduction (flour weight basis)

TABLE 18

| | | | | SR43 | |
|---|---|---|---|---|---|
| | | | SR42 | 33% SR + | |
| | | SR41 | 33% SR + | 25 ppm A. | |
| | SR40 | 33% SR | 25 ppm A. | Sucrase + | |
| Ingredient | Control | Control | Sucrase | 250 ppm SREB | |
| Wheat Flour | 100.0% | 100.0% | 100.0% | 100.0% | |
| Alternansucrase | — | — | 25 ppm | 25 | ppm |
| SREB Enzyme Blend | — | — | — | 250 | ppm |

| | | | | |
|---|---|---|---|---|
| Sugar | 9.0% | 6.0% | 6.0% | 6.0% |
| Salt | 1.0% | 1.0% | 1.0% | 1.0% |
| Calcium Propionate | 0.5% | 0.5% | 0.5% | 0.5% |
| Instant Yeast | 3.0% | 3.0% | 3.0% | 3.0% |
| Shortening | 2.0% | 2.0% | 2.0% | 2.0% |
| Water | 60.0% | 60.0% | 60.0% | 60.0% |

TABLE 19
SREB Enzyme Blend

| Ingredient | % of Enzyme Blend |
|---|---|
| SEBAmyl X100P (Fungal alpha amylase) | 12.0% |
| SEBake GA 800 (Glucoamylase) | 12.0% |
| Invertase | 2.0% |
| Maltodextrin | 74.0% |
| Total | 100.0% |

Volume: Breads with 25 ppm alternansucrase and breads with 25 ppm alternansucrase and 250 ppm SREB had 4-9% more volume than the 33% sugar reduction control and were closer in volume to the control (no sugar reduction).

TABLE 20—Volume for White Bread with 33% Sugar Reduction

TABLE 20

| | | | | SR43 |
|---|---|---|---|---|
| | | | SR42 | 33% SR + |
| | | SR41 | 33% SR + | 25 ppm A. |
| | SR40 | 33% SR | 25 ppm A. | Sucrase + |
| Attribute | Control | Control | Sucrase | 250 ppm SREB |
| Volume (mL) | 2018 | 1944 | 2014 | 2116 |
| Specific Volume (mL/g) | 4.52 | 4.36 | 4.53 | 4.76 |

Loaf Firmness: Method of measuring loaf firmness is described in example 2. Breads with 33% sugar reduction and 25 ppm alternansucrase and breads with 25 ppm alternansucrase along with the enzyme combination of 250 ppm SREB were 22-26% softer in loaf firmness than the 33% sugar reduction control and 26-29% softer than the control (no sugar reduction). These results suggest that these enzymes combinations can offer an added benefit of improving the softness of the bread with a 33% sugar reduction.

FIG. 8—Loaf Firmness of White Bread with 33% Sugar Reduction

Crust Color: Method for measuring the crust colour is described in example 3. The combination of 25 ppm alternansucrase and 250 ppm SREB helped in improving the crust color development (darker crust color) of the bread with 33% sugar reduction and was closer in crust color to the control (no sugar reduction)

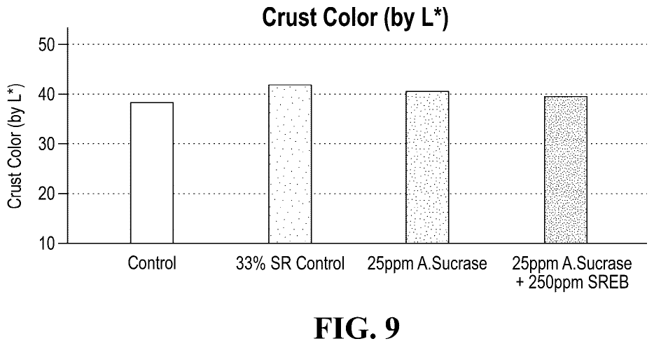

FIG. 9—Crust Color of White Bread with 33% Sugar Reduction

Day 7 General Sensory Attributes: For the general sensory attributes, breads were rated using the same process as Example 1. For sweetness, 1=no sweetness, 5=same sweetness as a reference sample (which was the control), and 9=much sweeter than the reference sample. See TABLE 21 for the sensory results.

Bread with 33% sugar reduction+25 ppm alternansucrase+250 ppm SREB rated closer in sweetness to the control (no sugar reduction) than the 33% sugar reduction control. The results suggest that the combination of 25 ppm alternansucrase+250 ppm SREB can be used to improve the sweetness, overall likeability, and total sensory score (by general sensory attributes) of white bread with 33% sugar reduction.

TABLE 21
Sensory Data for White Bread with 33% Sugar Reduction

| | | | | SR43 |
|---|---|---|---|---|
| | | | SR42 | 33% SR + |
| | | SR41 | 33% SR + | 25 ppm |
| | SR40 | 33% SR | 25 ppm | Alternansucrase + |
| Attribute | Control | Control | Alternansucrase | 250 ppm SREB |
| Crumb Grain | 3.9 | 3.5 | 4.0 | 3.4 |
| Aroma | 6.5 | 5.4 | 6.3 | 6.0 |
| Softness | 6.9 | 6.6 | 6.9 | 6.8 |
| Mouthfeel | 6.6 | 5.6 | 5.9 | 6.1 |
| Sweetness | 5.3 | 4.0 | 3.6 | 4.5 |
| Taste | 7.5 | 5.4 | 5.6 | 6.5 |
| Overall | 7.5 | 5.4 | 5.4 | 6.4 |
| Likeability | | | | |
| Total Sensory | 44.1 | 35.9 | 37.6 | 39.6 |
| Score | | | | |

Results: The results and data of this study suggest that
1. Adding 25 ppm alternansucrase along with 250 ppm SREB blend with 33% sugar reduction improved volume, crust color development, prolong softness (by loaf firmness). The treated bread was rated similarly in volume, crust colour development, to the control (no sugar reduction) than the untreated 33% sugar reduced bread.
2. Adding 25 ppm alternansucrase along with 250 ppm SREB blend with 33% sugar reduction improved sensory qualities and overall likeability. The treated bread was rated closer in sensory qualities and overall likeability to the control (no sugar reduction) than the untreated 33% sugar reduced bread.

The foregoing description of the invention has been set merely to illustrate the invention and is not intended to be limited. Since the modifications of the disclosed embodiments incorporating the spirit and substance of the invention may occur to the person skilled in the art, the invention should be construed to include everything within the scope of the disclosure.

While exemplary embodiments are described above, it is not intended that these embodiments describe all possible forms of embodiment. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, one or more features or characteristics may be compromised to achieve desired overall system attributes, which depend on the specific application and implementation. As such, to the extent that any embodiments are described as less desirable than other embodiments or prior art implementations with respect to one or more characteristics, these embodiments are not outside the scope of the disclosure and can be desirable for particular applications.

We claim:

1. A method of producing baked goods with less added sugar than a control of regular baked goods where the baked goods have one or more sensory qualities that are better than the control of regular baked goods containing more sugar, where the method comprises adding the enzyme alternansucrase, with or without other enzymes.

2. The method of claim 1, wherein the one or more sensory qualities include a prolonged softness, a delay in staling, a finer grain, and an improved foldability, an improved springiness, an improved aroma, an improved crust colour, an improved taste and/or an improved overall texture.

3. The method of claim 1, wherein the enzyme alternansucrase reduces the amount of added sugar in baked goods by up to 50% (w/w) as compared to the amount of sugar added to the control of regular baked goods.

4. The method of claim 1, wherein the enzyme alternansucrase is added in an amount of ranging from 0.5 to 500 PPM based on a flour weight of the baked goods.

5. The method of claim 1, wherein the enzyme alternansucrase is added with one or more other enzymes including fungal alpha amylase, glucoamylase, invertase, and/or maltogenic amylase.

6. The method of claim 1, wherein an activity level of alternansucrase used standalone or in blend preparation is 4100 U/g.

7. The method in claim 1 wherein the enzyme alternansucrase, with or without other enzymes, is added in a liquid or solid form.

8. The method of claim 1, wherein enzyme blend of alternansucrase can be added at several steps during the baking process, including during dry or wet blending of ingredients and/or dough-making.
